(19) United States
(12) Patent Application Publication
(10) Pub. No.: US 2020/0166990 A1
(43) Pub. Date: May 28, 2020

(54) Device and methodology for the interaction through gestures and movements of human limbs and fingers

(71) Applicants: Michele Franzese, Potenza (PZ) (IT); Nicholas Caporusso, Bari (BA) (IT)

(72) Inventors: Michele Franzese, Potenza (PZ) (IT); Nicholas Caporusso, Bari (BA) (IT)

(21) Appl. No.: 16/612,751

(22) PCT Filed: Jan. 4, 2018
(86) PCT No.: PCT/IT2018/050002

§ 371 Date: Nov. 11, 2019

(30) Foreign Application Priority Data
Jun. 12, 2017 (IT) 102017000037702

(51) Int. Cl. G06F 3/01; G06F 3/0346; G06F 3/038

(52) U.S. Cl. CPC G06F 3/011; G06F 3/017; G06F 2203/0331; G06F 3/038; G06F 3/0346

(57) ABSTRACT

A device that enables the interaction, through gestures and movements, of parts of the human body, such as limbs and fingers, using one or more wearable or manipulable electronic devices and a computer, includes a universal invariant central unit and an accessory to be worn on a specific part of the human body that are connected through a universal interface.

### BRIEF DESCRIPTION OF THE INVENTION

The invention here described regards a tool for the interaction through gesture and movements of human body (such as fingers, limbs, head, shoulder, pelvis, ankles, feet) by means of one or more devices whose utilization can be simultaneous.

Such devices consist of:
an invariant central unit equipped with sensors to acquire impulses as quantitative components characterizing the movement of one or more parts of the body in the space;
a properly designed accessory to be worn on a specific part of the body.

The central unit and the accessory are both equipped with a standard connection interface, which links them through an anchor bolt.

The connection interface allows the central unit to be linked to the different accessories, each one properly designed for a specific part of the body or to be manipulated by the user.

Moreover, the invention provides a methodology to codify and transmit the impulses, related to the position and to the components of the movement in the space of one or more parts of the body, into control signals suitable for an electronic processor.

Such methodology includes a software—opportunely designed to interact with multiple applications—capable to simultaneously acquire different control signals coming from the different connected devices, to recognize the part of the body where the signal comes from and to generate a differentiated control signal depending on the movement, the part of the body and the application. The methodology includes a system to extent the uses of such invention defining specific actions related to specific movements, coming from specific parts of the body, and to associate these actions to specific commands depending on the applications.

The complete invention regards the methodology and the related devices to transmit to a computer the impulses coming from different points of limbs or fingers where the device/devices is/are connected, in order to record these movements and to convert them into control signals.

The invention here described is particularly indicated to be used for many different applications, such as (and not only):

video games, especially in case of immersive interaction scenarios;

music, especially for musical melodies modulation;

arts, especially for modulation of lights, sound and any scenography components;

graphics, as tool of 2D and 3D design and modelling;

professional field, especially as tool for controlling presentation and applications;

health and medical field, especially in case of people with movements restrictions;

school and education, especially for learning virtual environments;

sport and training, especially as sport simulation tool, in order to maintain own level of training.

Moreover, the invention is suitable to be used in case of users' mobility and it is conceived to be interoperable with smartphones, PCs, notebooks, consoles, smart TV and with any other devices equipped with compatible medias.

### Invention Field

In addition to the standard input devices, many innovative devices have been developed in recent years to interact—through the recognition of the position and movement of the body, of the single limbs and even of the hand fingers—with PCs, consoles, and state-of-art mobile devices to control software, like video games, synthesized musical instruments, virtual environments and 3D-objects.

There are two categories of tools for the acquisition and recognition of body position and movement:

infrastructure-based systems, in which the sensor is placed on a special device installed in the surrounding environment and it is capable to detect the user movements;

wearable or manipulable systems, in which the sensor is worn by the user (or hold in his hands) and it detects the movement of the body or of a limb.

In the following some state-of-art technologies based on the acquisition and recognition of body position and movements and on the decoding of their components into control signals, are listed:

photo and video cameras: they allow to acquire user's static and dynamic images from which it is possible, by means of specific algorithms, to extract identifying elements of body position and movement;

infrared sensors: they allow to acquire static and dynamic images and to extract in a more convenient way the elements related to the frequency of infrared light from which it is possible, by means of specific algorithms, to extract identifying elements of body position and movement;

infrared laser scanners and other laser-based technologies: they allow to generate a points cloud of a portion of the space framed by the laser beam, where each point is represented by its position and distance from the sensor;

coloured markers: they are used because they are easily recognized by an RGB sensor;

markers of reflective material: they are used because they are easily recognized by an infrared sensor.

An example of these devices is Microsoft Kinect, a console that allows to recognize the user's position and movement through the analysis of images coming from a RGB sensor (camera), an infrared sensor and an infrared laser.

The present invention falls within the field of wearable or manipulable systems, usually defined as “controllers”, although it includes some infrastructure-based elements. An example is represented by the Nintendo Wii, a video games console based on a remote controller that detects and converts the user's movements into commands, allowing to simulate a tennis racket, a baseball bat or a boxing glove in a virtual video-gaming environment.

In the following some interaction-aimed technologies, useful for the acquisition and recognition of the movement, are listed:

accelerometer: it quantifies the acceleration of an object with respect to the three axes of the space;

gyroscope: it defines the absolute orientation of an object in space through three degrees of freedom, each of them corresponding to an axis;

magnetometer: it defines the orientation of an object relative to the Earth's magnetic axis with respect to the three axes of space;

surface electrode: it allows the non-invasive recognition of the activation of one or more muscles through the acquisition of the muscles electrical activity detected by the skin;

bending sensor: it defines the flexion of a finger through a resistive band whose impedance decreases as the bending angle increases;

inertial units: they integrate one or more sensors for the detection of the movement inertial components, like accelerometer, gyroscope and magnetometer. Due to the high versatility, the very low cost, the huge diffusion on the market and the miniaturization of the components, the inertial units have become the most used acquisition system for movement recognition. They have become a standard in both mobile devices and wearable controllers.

### FIGURES DESCRIPTION

For illustrative purposes, the invention is now described with reference to the attached figures.

FIG. 1a shows the main device of the invention worn on the user's left-hand index finger, in which the numbers refer to: device (1) equipped with a central unit (2) and an interchangeable accessory (3), which is suitably shaped like a ring to fit the user's finger (4).

FIG. 1b shows the main device of the invention, in which the numbers refer to: device equipped with a central unit (2) and an interchangeable accessory (3), connected via a common interface (5) which allows an interlocking coupling between the lower part of the central unit (2) and the upper part of the interchangeable accessory (3). The latter is suitably shaped like a ring (6) to fit the user's finger.

FIG. 2a shows an exploded view of the main device of the invention, in which the numbers refer to: device equipped with a central unit (2) and an interchangeable accessory (3), connected by means of a common interface (5). In particular the latter links the lower part (5a) of the central unit (2) and the upper part (5b) of the interchangeable accessory (3) through interlocking coupling.

FIG. 2b shows an exploded view of the main device of the invention, in which the numbers refer to: device equipped with a central unit (2) and an interchangeable accessory (3), connected by means of a common interface (5). In particular the latter links the lower part (5a) of the central unit (2) and the upper part (5b) of the interchangeable accessory (3) through interlocking coupling.

FIG. 2c shows an exploded view of the interface between the central unit (2) and the interchangeable accessory (3) of the main device. The numbers in the picture refer to: device equipped with a central unit (2) and an interchangeable accessory (3), connected by a common interface (5) that allows to link the lower part (5a) of the central unit (2) and the upper part (5b) of the interchangeable accessory (3) be means of interlocking coupling. The lower part (5a) of the central unit (2) represents the upper side (5a) of the common interface (5) and the upper part (5b) of the interchangeable accessory (3) represents the lower side (5b) of the common interface (5). The upper side (5a) of the interface (5) is equipped with plugs (5a1, 5a2, 5a3 and 5a4) and the part side (5b) of the interface (5) is equipped with the corresponding housings (5b1, 5b2, 5b3 and 5b4), so that elements 5a1, 5a2, 5a3 and 5a4 can be coupled with elements 5b1, 5b2, 5b3 and 5b4 ensuring an interlocking coupling. Consequently, the central unit (2) and the upper part (5b) of the interchangeable accessory (3) are perfectly fitted.

FIG. 2d shows an exploded view of some components of the main device of the invention, in which the numbers refer to: central unit (2), whose outer shell is composed of a hollow upper part (2a) and a lower part (2b) properly designed for an interlocking coupling with the upper part. Once connected, the hollow upper part (2a) and the lower one (2b) compose a compartment for containing alle the electronic components (7) of the central unit (2). On the lower side of the lower part (2b) of the central unit (2) there are the plugs (5a1, 5a2, 5a3 and 5a4), which represent the upper side (5a) of the universal interface (5); whereas on the upper part (5b) of the interchangeable accessory (3) there are the corresponding housings (5b1, 5b2, 5b3 and 5b4) which represent the lower side (5b) of the universal interface (5).

FIG. 3a shows an exploded view of some components of the main device of the invention, in which the numbers refer to: upper hollow part (2a) of the shell of the central unit (2), whose upper side presents four shaped through-holes (2a1, 2a2, 2a3 and 2a4) and where one of its side presents another shaped through-hole (2a5); translucent sheet (8), whose upper side is equipped with four plugs (8a, 8b, 8c and 8d), is shaped to fit with the through-holes (2a1, 2a2, 2a3 and 2a4) ensuring an interlocking coupling. The electronic components (7) consist of a printed electronic circuit (9) and a battery (10) and they are enclosed between the upper hollow part (2a) of the central unit (2) shell and its lower part (2b). The translucent sheet (8) lies on the printed circuit (9) of the electronic components (7).

FIG. 3b shows an exploded view of some components of the main device of the invention, in which the numbers refer to: translucent sheet (8) whose upper side has four plugs (8a, 8b, 8c and 8d). The electronic components (7) consist of a printed electronic circuit (9) and a battery (10). In particular the printed electronic circuit (9) consists of: a microcontroller (11) that supervises the operation of the electronic components of the central unit (2), an inertial unit (12) for the acquisition of the movement components with nine degrees of freedom (accelerometer, gyroscope and magnetometer on three axes—X, Y and Z), a feeding system (13) connected to the battery (10), an USB connector (14), a wireless information transmission system equipped with an antenna (15), four buttons (16a, 16b, 16c and 16d) and four LEDs (17a, 17b, 17c and 17d); the battery (10) consists of a charging system (18).

FIG. 4 shows the electric scheme of the central unit electronics (2) of the main device, in which the numbers refer to: electrical scheme (11a) of the microcontroller (11), which supervises the operation of the electronic components (7), the electric diagram (12a) of the inertial unit (12) for the acquisition of movement components with nine degrees of freedom (accelerometer, gyroscope and magnetometer on the three axes), wiring diagram (14a) of the components for communication by USB port (14), wiring diagram (13a) of the power supply system (13), wiring diagram (18a) of the battery (10) charging system (18).

FIG. 5a shows the upper side of the printed circuit of the central unit (2) of the main devices, in which the numbers refer to: upper side (9a) of the printed circuit (9) including the housing (11b) of the microcontroller (11), which superintends the operation of the electronic components, the housing (14b) of the USB connector (14), the housing (13b) of the supply system (13) and the housing (10b) of the battery connections (10).

FIG. 5b shows the lower side of the printed circuit of the central unit (2) of the main devices, in which the numbers refer to: lower part (9b) of the printed circuit (9) including the housing (14b) of the components for communication by USB port (14) and the housing (12b) of the inertial unit (12) elements for the acquisition of the movements components with nine degrees of freedom (accelerometer, gyroscope and magnetometer on three axes of the space).

FIG. 6a shows the front view of the main device and of a set of accessories of the invention, in which the numbers refer to: central unit (2) equipped with the upper side (5a) of a universal interface (5). The latter is composed of universal and invariant anchor elements properly designed to link the upper side (5a) with the universal and invariant housings of the lower side (5b) of each universal interface (5) by means of interlocking coupling. All the elements (3a1, 3a2, 3a3 and 3a4) of the interchangeable accessory (3) are suitably shaped like a ring to fit the user's finger and they have different internal diameters for all of the user's fingers or for the different sizes of users' fingers.

FIG. 6b shows different configurations of the main device of the invention worn on the fingers of both the hands, in which the numbers refer to: prototypes (1a1 and 1a2) of the device (1); each of them (1a1 and 1a2) is equipped with a central unit (2) and a prototype (3a1 and 3a2) of the interchangeable accessory (3), which is opportunely designed like a ring to fit different user's fingers (4a1 and 4a2).

FIG. 7a shows different configurations of the main device of the invention obtainable with different specific accessories, in which the numbers refer to: different configurations (3a, 3b and 3c) of the interchangeable accessory (3), each of which is equipped with the lower side (5b) of the universal interface (5), where it hosts the housings (5b1, 5b2, 5b3 and 5b4). All the possible configurations (3a, 3b and 3c) of the interchangeable accessory (3) can be linked to the same central unit (2), which is equipped with the upper side (5a) of the universal interface (5) consisting of the plugs (5a1, 5a2, 5a3 and 5a4). The interchangeable accessory (3) is properly shaped like a ring (3a) to fit the user's finger, like a band (3b) to fit the user's ankle or forearm, or moreover like a cylinder (3c) to be manipulated by the user and put on a flat surface. FIG. 7b shows different variants of the main device of the invention obtainable with different specific accessories, in which the numbers refer to: different configurations (3a, 3b and 3c) of the interchangeable accessory (3), which is suitably shaped like a ring (3a) to fit the user's finger, like a band (3b) to fit the user's ankle or forearm and like a cylinder (3c) to be manipulated by the user and put on a flat surface. All the accessories are equipped with light actuators (19), whose different design (19a, 19b and 19c) is adapted to the different shape of the accessories (3a, 3b and 3c).

FIG. 8a shows two possible configurations of the main device of the invention obtainable with two different specific accessories, in which the numbers refer to: prototypes (1a1 and 1b1) of the main device (1), each of which is equipped with the same central unit (2) mounted on different prototypes (3a1 and 3b1) of the interchangeable accessory (3), which is opportunely shaped like a ring (3a1) to fit the user's finger or like a band (3b1) to fit the user's hand.

FIG. 8b shows another possible configuration of the main device of the invention, in which the numbers refer to: possible configuration (1b1) of the main device (1) equipped with the central unit (2) mounted on a specific configuration (3b1) of the interchangeable accessory (3), opportunely shaped like a band to fit the user's ankle (4b).

### STATE OF ART

The state of art includes numerous devices capable to interact with PCs and smartphone through the movement of the fingers and the hand. Patent application no. US20040263473 describes a system capable to recognize the movement of the fingers by means of wearable rings. This system is based on a mix of wearable and infrastructure-based elements, where the rings only have the purpose of supporting markers recognized by an external video camera. This system is not suitable for interaction in mobile contexts and it is not wearable.

The U.S. Pat. No. 5,832,296 describes a system based on a ring capable to interact with any intelligent device present in the environment, including pressure and touch sensors, except for motion sensors; it is not versatile; it cannot react with a plurality of accessories and it cannot use different devices simultaneously.

The possibility of connecting a single inertial unit and of using different devices—eventually worn on different parts of the body—represents the limit of most of the systems of the state-of-art. In fact, such functionalities are not foreseen/included/described or suggested in the state-of-art of the devices listed below (which are not individually discussed for sake of brevity):

### Submitted Patents

US20030214481
US20120086636
WO2016044035US6850224;

### Patents

U.S. Pat. No. 6,587,090 Research projects:
   doi: 10.1145/259963.260056
   doi: 10.1145/2541831.2541875
   doi: 10.1145/2160125.2160137
   doi: 10.1109/CISIS.2012.123

### Proposed or Cited Devices

http://muvinteractive.com
http://www.fujitsu.com/global/about/resources/news/press-releases/2015/0113-01.html
http://www.patentlyapple.com/patently-apple/2014/10/microsoft-invents-an-interesting-multi-purpose-wireless-ring.html

Moreover, in recent years some projects on crowdfunding platforms have attempted to introduce ring-shaped interactive devices. Examples of these projects are:

Mycestro (http://www.mycestro.com)

Smarty ring (https://www.indiegogo.com/projects/smarty-ring-3)

Fin (http://www.wearfin.com)

Nod (http://startup-videos.com/hellonod)

SmartRing (https://www.tamo.com/doi-smartring)

Ring (https://www.kickstarter.com/projects/1761670738/ring-shortcut-everything)

As it can be seen from the comments on the above-mentioned web sites, none of the projects mentioned above has been “reduced in practice” (namely produced, sold and/or offered for sale) after collecting funds from network users.

Regardless of the type of project, all the known state-of-art products are based on a single type of device that can only be used on one part of the body or in any case it cannot be interchangeable.

### DESCRIPTION OF THE INVENTION

Unlike all the state-of-art systems, the device here presented separates the central unit from the accessories and it introduces a standard interface for coupling a single central unit to different accessories. This feature, contrary to all the other systems, provides large versatility without any increasing of the costs: in fact, an available device with new features is obtained just replacing an inexpensive accessory.

Since the state-of-art devices are conceived for a single functionality, they have no possibility to recognize the part of the body to which the devices are placed on. Conversely, such innovative and unique feature characterizes the device of the present invention.

Moreover, all the state-of-art devices do not provide the possibility of simultaneous interacting with multiple tools and acquiring control signals from them, which is an essential and unique feature of the device of the present invention.

In other words, the present invention is based on an electronic system and on a methodology for acquiring and recognizing the position and the movement (individually or simultaneously) of an arbitrary number (one or more) of parts of the body (such as limbs and fingers), and on devices and methodology for converting them into control signals for external applications or tools: then the user can command any application with the movement of a finger, of a hand or of one or more parts of the body.

For this purpose, the device includes one or more sensors, such as accelerometer, gyroscope and magnetometer, optionally integrated into a single inertial measurement unit, capable of detecting the acceleration, the absolute orientation and the relative orientation referred to the earth rotation axis. Each measurement is referred to the three space axes, then it is acquired with three degrees of freedom. Such movement components can be coded in signals processed by the central unit through signal processing algorithms, such as Kalman filters or signal windowing systems. Subsequently, the signals are coded in elements suitable for representing the movement through measure standard units, such as radians or angles, so that the data detected by the sensors can be transmitted—in raw form or after processing—to an external device capable of interpreting them. The transmission of the coded signals to an external device can be carried out via cable or wireless systems, such as a serial cable connection through the USB port or a wireless connection through a Wi-Fi or Bluetooth system equipped with an internal or external antenna (with reference to low-power protocols, such as Bluetooth Low Energy, BLE).

The sensors included in the device of the invention are integrated in an electronic circuit, powered by a battery that can be recharged even during the use, by means of a charging system, such as the USB port or an induction system. The electronic circuit and the battery are installed into a shell composing the central unit. The shell is made of a material, such as plastic, suitably treated with distinctive colour or refracting paints, so that it can be efficiently detected by a camera or by an infrared sensor.

The device can be adapted—thanks also to its small dimensions—to different parts of the body (such as the fingers, the hand, the forearm, the shoulder, the head, the abdomen, the pelvis, the leg, ankle and foot) through the use of different accessories, all connected by a standard interface to the same central unit. Consequently, the device can be easily worn on different parts of the user's body by applying the invariant central unit to one of the accessories thanks to the universal interface.

In this case the term “invariant” means that the central unit does not change and it is not modified.

The accessories have different shapes, like rings, bands or bases. The accessories are opportunely designed to allow an appropriate anchor to the specific part of the user's body, like the fingers, the forearm and the ankle, etc., or they can be conveniently manipulated with one or two hands to allow the device to perfectly adhere to the user's body: then any spurious or wrong signals caused by independent movements of the device with respect to the body part (then caused by an inappropriate coupling) are minimized.

The accessories can be advantageously made of different materials like plastic, rubber, silicone, elastic fabric or a mix of materials. All the accessories are equipped with the lower side of the universal interface opportunely designed to guarantee an interlocking coupling with the upper side of the universal interface located at the bottom of the central unit. The interface can be implemented in the form of rail systems, bayonet systems or any other systems that ensure a interlocking coupling capable of minimizing spurious and wrong movements due to relative displacements between the accessory and the central unit. The separation of the central unit from accessories, then the possibility of connecting them through a single common and standard universal interface, is one of the fundamental aspects of the device of the present invention.

The accessories can advantageously and optionally integrate sensors, actuators and components, like LEDs, vibrotactile actuators, capacitive sensors and batteries, connected to the central unit through a special communication bus located inside the coupling interface, between the central unit and the accessory.

This device is particularly useful for interacting with a PC or a smartphone and for sending commands to any application by simultaneously moving one or more limbs like one or more fingers, one or two hands, an ankle or different parts of the body. The possibility of simultaneously wearing and using one or more devices placed in different parts of the body and the possibility of simultaneously acquiring and managing different signals coming from multiple devices are some of the fundamentals features of both the device and the methodology of the invention.

Moreover, the device can include further sensors for acquiring user's input, such as touch and pressure sensors based on buttons or capacitive sensors. Furthermore, the device can include short-range information transmission systems like Near-Field Communication (NFC) systems.

The device can further include actuators to provide an output to the user, like LED lights, audio speakers or vibrating-tactile actuators.

The device is associated with a methodology, which is an integral part of the present invention, including components that allow the simultaneous acquisition of impulses coming from different devices, the identification of the part of the body where each device is placed on, the recognition of the movement of each part of the body and the conversion of such movement into specific control signals. These latter can be associated to a specific movement of a part of the body or to a specific set of simultaneous movements of different parts of the body. For this purpose, the methodology includes systems based on quaternions or other classification algorithms particularly suitable for the analysis and processing of the movement. Moreover, the recognition of the movement components can be performed through the connection of an accessory equipped with a specific element, for example an NFC circuit, in which information relates to the type of accessory is encoded; alternatively, the recognition can be automatically performed, based on the detected signals, or by user manual association.

Moreover, the device is combined with a methodology, which is an integral part of the present invention, which includes some components that allow the definition of new user-defined commands based on user's movements and acquired by one or more devices. For this purpose, such methodology includes systems based on classification algorithms particularly suitable for feature processing, on artificial intelligence algorithms and on supervised or non-supervised automatic learning, like neural networks.

Finally, the device is combined with a methodology, which is an integral part of the present invention, which includes some components that allow to specialize the command associated to any movement or to a set of movements simultaneously realized to the specific application/context with which the user interacts. Then the movements can correspond to different commands depending on the interaction application/context. For this purpose, this methodology can be implemented in software libraries that can be integrable into applications developed ad hoc or in external applications.

For example, a user can interact with a music program and turn up the volume by raising his hand or, conversely, lowering it by moving his hand down; similarly, the user can interact with a photo editing program and increase the brightness of the image by raising the hand or, conversely, decrease it by moving the hand down.

Another example can be an image display application, in which the user can enlarge the image by extending both hands or reducing it by moving the hands together.

Another example can be an application in which the user can respond to a phone call with a movement of the hand to the right, reject it with a movement to the left, mute the ringtone with a downward movement or send an automatic message with an upward movement.

Another example can be an application for displaying slides in which the presentation can be controlled with the movements of the hand, turning one page by moving the hand to the left and returning to the previous page by flicking to the right.

Another example can be a boxing videogame, in which the user can control his character by throwing punches with his hands in the air so that the movements are translated into actions performed by the videogame character.

Another example can be a penalty shoot-out simulation in which the direction of the kick of the user determines the direction of the ball moving to the net in the virtual environment and the consequent reaction of the goalkeeper controlled by the computer.

Another example can be a three-dimensional modelling software, in which the user can rotate the virtual object simply by rotating the hand. These are just some examples of possible interactions, but it is intuitive that through such device it is possible to manage the home automation, a computer, a smartphone, the centralized system of a car, an alarm system or anything else that can be managed by a computer connected by cable or wireless.

The interaction system of the invention, if compared to the other systems, has significant advantages such as:

low production cost, since all the necessary components are available on the market at a limited cost;

large catchment area, since it can be commonly used by people with different interests, from music to entertainment, and in the professional field also;

versatility, since it can be integrated with any type of computer and with any operational platform and it can be associated with any part of the body thanks to the interchangeable accessories and the standard interface;

modularity, thanks to the possibility of using more devices at the same time and consequently widening the library of available controls and commands;

portability, thanks to its small size;

interoperability with different devices, operating platforms and applications, thanks to the possibility of integrating standard communication systems;

possibility of unlimited extension, thanks to the possibility of integrating standard applications and developing ad hoc applications;

possibility of high customization, since the user can define commands and controls based on their preferences and their movements. Therefore, the present invention has to include:

at least one motion sensor capable to recognize multiple signals, including acceleration, orientation in space and orientation with respect to the Earth's rotation axis, like a 9-degree freedom inertial unit (accelerometer, gyroscope, magnetometer), which allows to recognize movement and orientation in space and to associate to them additional commands and controls;

at least one system for recognizing the position of the device within the field of view of an external device worn by the user or present in the surrounding environment, like a partially or total reflective material or paint of moreover a colour particularly suitable to be detected by RGB or infrared sensors;

at least one electronic card for processing the signal coming from the sensors, for filtering such signals and for converting analog or digital signals into digital signals to be transmitted to an external device;

at least one communication circuit with an external device by means of cable or wireless communication protocols such as a serial or Bluetooth protocol, and a circuit of implementation of signals coming from external devices to which it is connected;

at least one central unit equipped with one of the two sides of the universal interface and including the electronic components;

at least one software for managing the device (available on request at the website: www.getverso.it) capable to interpret the movement components through specific techniques, such as quaternions or Euler's corner, and capable to translate such components into control signals (for example by associating an angle with a movement of a cursor on the screen);

at least one universal interface consisting of two sides opportunely designed for ensuring interlocking coupling;

at least an accessory suitable for wearing the device or making it suitably manipulated; then, it must be opportunely shaped to fit any part of the user's body and it must be equipped with one side of the universal interface so that it can be linked to the central unit;

at least one sensor for acquiring input from the user, like a pressure sensor applied to the electronic control board card and accessible through the shell of the central unit;

at least one visual actuator to provide output to the user, like a bright LED applied on the electronic control board card and accessible through the shell of the central unit;

at least one battery for independent operation of the device without connection to the electricity grid;

at least one system for recharging the battery when the device is connected to the electricity grid;

at least one system for encoding and decoding information;

at least one system for acquiring signals from different devices simultaneously connected;

at least one system for recognizing the signal coming from a specific part of the body;

at least one system for defining the commands associated to specific movements;

at least one system for defining the action corresponding to a specific movement related to a specific application or context.

Such sensors and actuators encode messages or information related to the position and movement of a part of the body.

A further object of the present invention is an accessory including:

at least one sensor to recognize an input from the user;

at least one actuator to provide feedback to the user;

at least one battery to provide additional power to the device;

at least one communication bus to communicate with the central unit;

wherein the accessory according to the present invention:

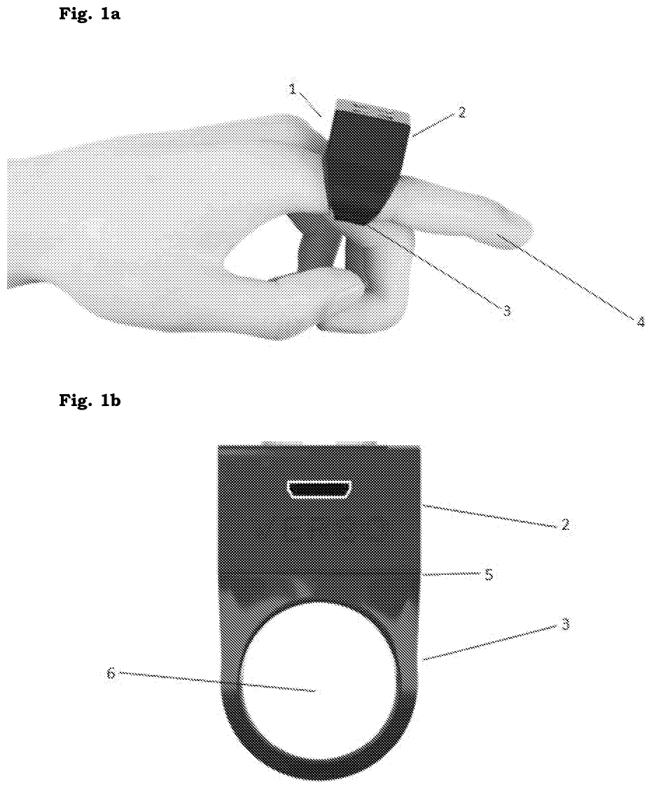

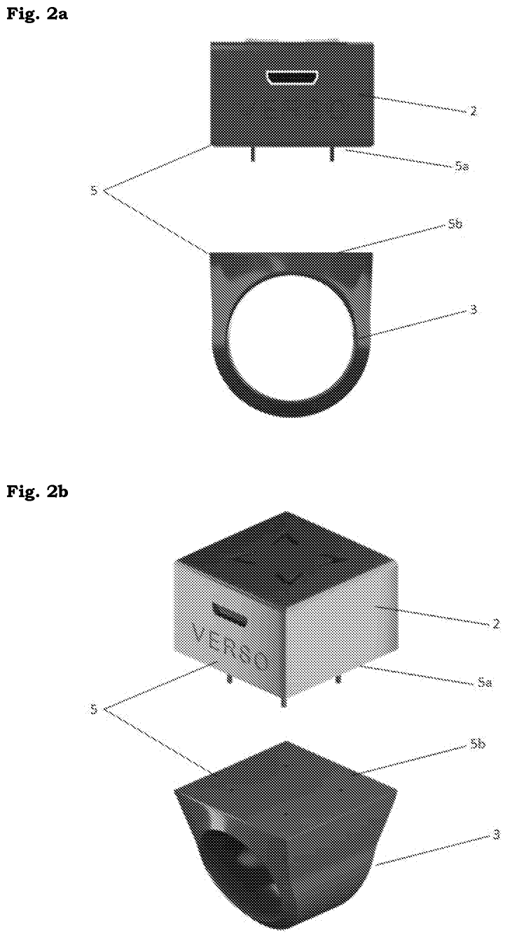

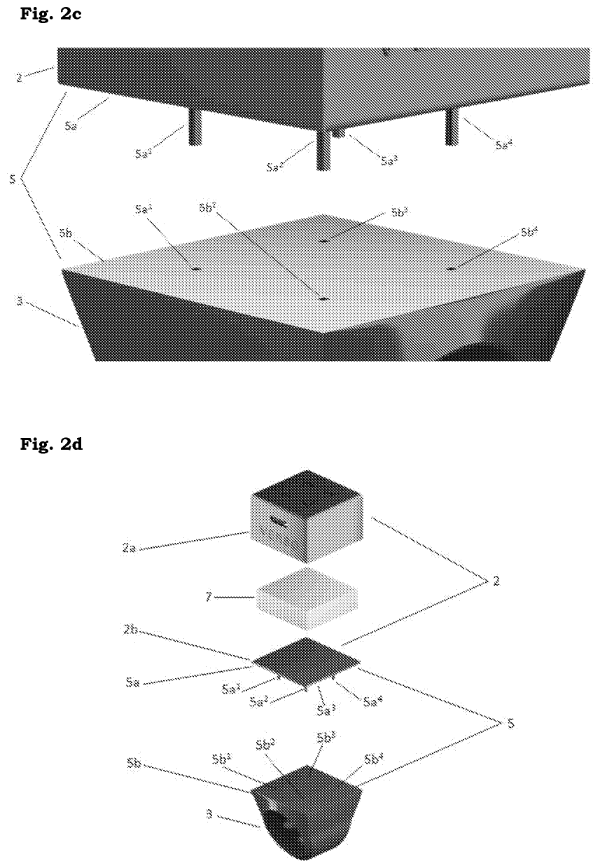

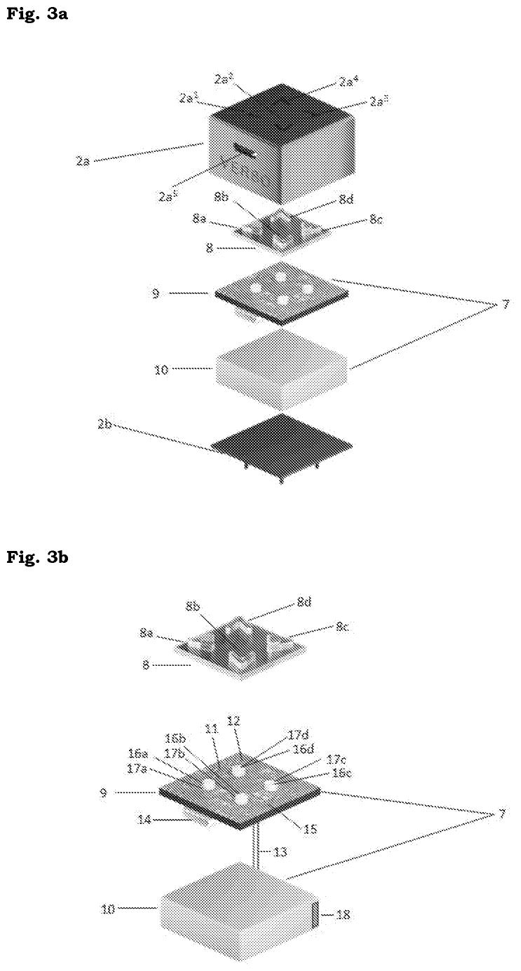

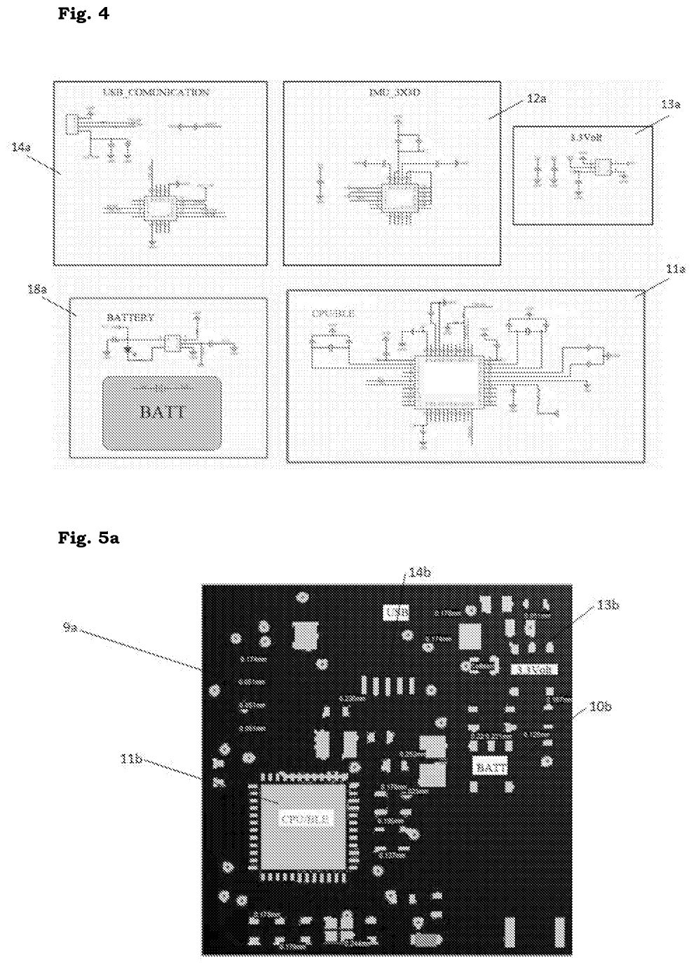

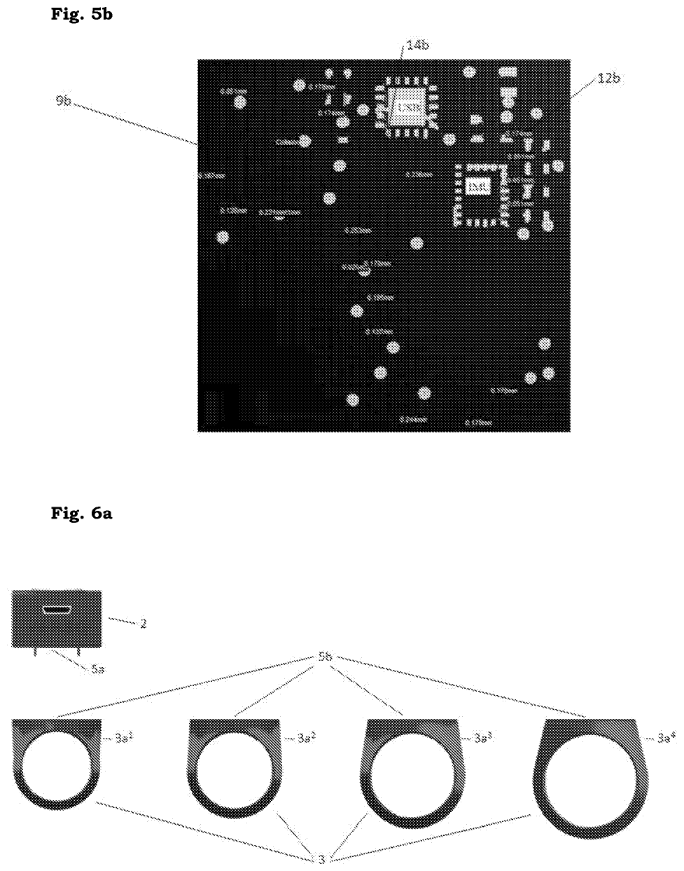

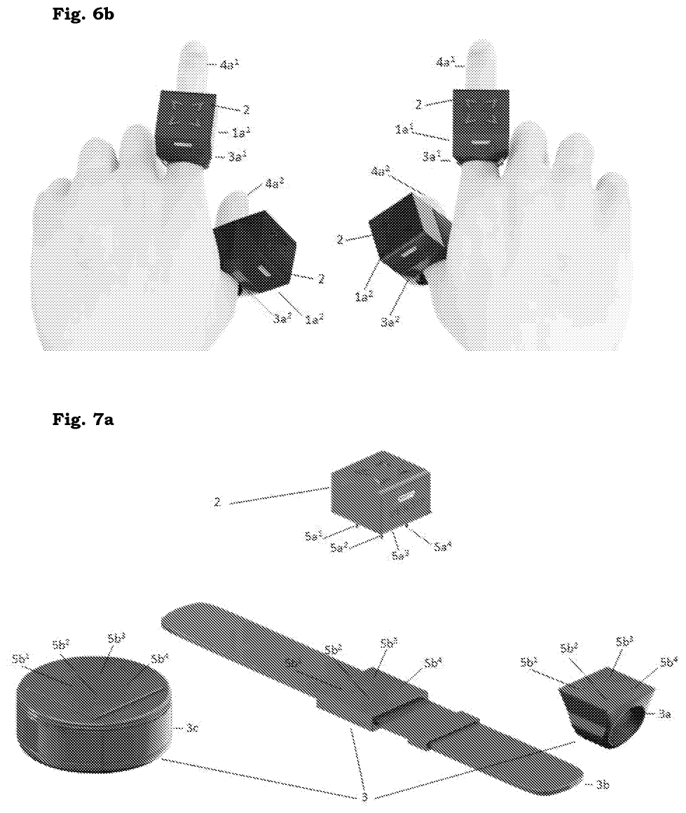

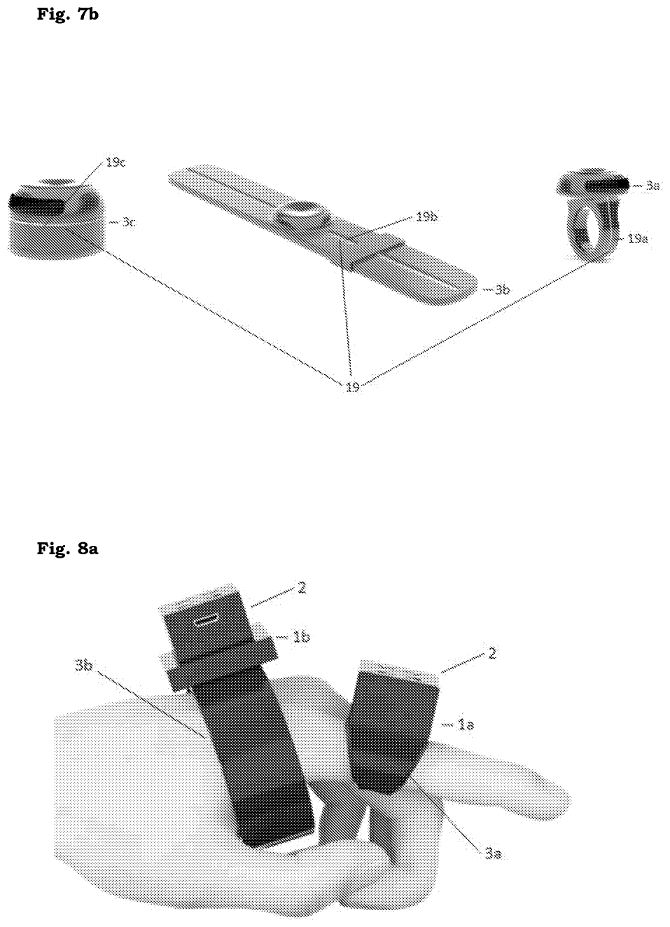

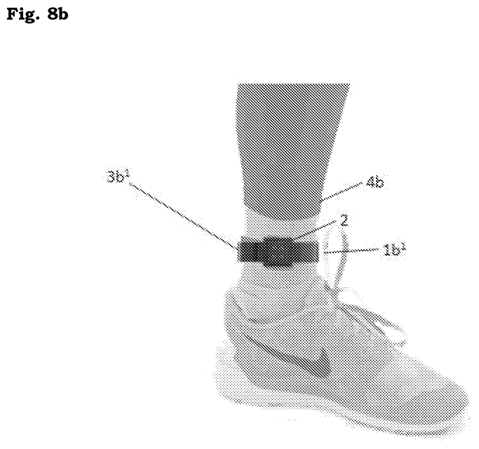

the accessory can have any shape suitable for any purpose it is realized, for example it can be a ring-shaped or band-shaped device, as shown in FIGS. 1-10;

the accessory can have an universal interface that ensures interlocking coupling between the central unit and the accessories; such interface can have any shape and structure suitable for the purpose for which it was defined, for example it can consist in a rail system, a matrix and punch system, in a clip system or in a rotary clamping system;

the accessory can be fixed, through the accessories, to any part of the user's body, for example it can be placed on a finger, on the back of a hand, on the wrist, on the forearm, on the chest, on the ankle, on the foot, on the abdomen and on the pelvic area;

the accessory can be useful to recognize movements such as flexion and extension, rotation, abduction, adduction, pronation, subversion, supination, inversion, elevation, ante position, depression, back-position, fingers, wrist, any articulation or any part of the body, always in non-invasive mode;

the accessory can be useful for the interaction of the user with different external devices equipped with a compatible communication systems;

the accessory can be useful in various application fields, for example, entertainment, professional, health, music, art, sports;

the accessory allows the simultaneous use of multiple devices each of which associated with a part of the body;

the accessory allows the storage of the data associated to the movement in order to analyse it in real time or in a later moment;

the accessory allows the definition and memorization of movement patterns and the association of such patterns with predefined actions related to a specific application/context of use.

### DETAILED DESCRIPTION OF THE INVENTION

### Example 1

A possible configuration of the main device of the present invention is explained below.

### Components:

Inside the device the following components are installed/integrated:
an inertial unit with 9 degrees of freedom (accelerometer, gyroscope, magnetometer) that allows to recognize the movement and the orientation of the index finger in the space and to associate such movement to additional commands and controls;
a rechargeable battery during the use;
a system for Bluetooth Low Energy and USB connection.

By means of the indications shown in FIGS. 1-10 of the patent application here presented, a skilled technician is able to construct the electronic control board card of the device in accordance with the present invention.

### Mechanical Structure:

The mechanical structure of the device includes:
the shell of the central unit that incorporates the electronic components;
a ring-shaped accessory designed to be worn by the user on the index finger whose diameter is suitable for user's index finger size;
the universal interface between the shell of the central unit and the ring-shaped accessory, divided into two sides as previously described.

### Functionalities:

The sensors of the device can be used to acquire, on separate channels, each component of the movement detected by the accelerometer, the gyroscope and the magnetometer on the three axes X, Y and Z and to convert the data contained by these 9 signals into patterns constantly processed by the device software.

By opening a dedicated application, it is possible to visualize, through a representation on a display of the three-dimensional model of the ring, the orientation and movement of the ring in the space. By moving the finger, the user can interact with the virtual model, moving or rotating it specular to the movement or the rotation of the real element.

By opening a well-known application, like Spotify, the user can change the track by scrolling with the right hand, or lower or raise the volume by moving the hand up or down.

By opening a well-known software, like Microsoft PowerPoint, the user can start a presentation by raising his hand, he can scroll the slides by flicking left or right and close the presentation by lowering his hand.

### Example 2

A possible configuration of the main device of the present invention is explained below.

### Components:

Inside the device the following components are installed/integrated:
an inertial unit with 9 degrees of freedom (accelerometer, gyroscope, magnetometer) that allows to recognize the movement and the orientation of the index finger in the space and to associate such movement to additional commands and controls;
four reset buttons with tactile feedback that allow to recognize the user's input and to associate it to further commands and controls;
a rechargeable battery during use;
a system for Bluetooth Low Energy and USB connection.

By means of the indications shown in FIGS. 1-10 of the patent application here presented, a skilled technician is able to construct the electronic control board card of the device in accordance with the present invention.

### Mechanical Structure:

The mechanical structure of the device includes:
the shell of the central unit that incorporates the electronic components;
a ring-shaped accessory designed to be worn by the user on the index finger whose diameter is suitable for user's index finger size;
the universal interface between the shell of the central unit and the ring-shaped accessory, divided into two sides as previously described.

### Functionalities:

The sensors of the device can be used to acquire, on separate channels, each component of the movement detected by the accelerometer, the gyroscope and the magnetometer on the three axes X, Y and Z and to convert the data contained by these 9 signals into patterns constantly processed by the device software.

Vice versa, the four buttons can be used to actuate different commands that allow to carry out specific actions in combination with the movement of the limbs.

By using an ad hoc application for artists, the user can use the hand movements for drawing: pressing one of the four buttons, corresponding to the “brush” command, the movement made by the user is converted into a brush stroke on a plane or in a space displayed on the screen, and furthermore, releasing the button, the movement has no effect, so that the user can rest. By pressing another button, corresponding to the “eraser” command, the movement of the hand on the brush stroke previously impressed can cancel it totally or partially. By pressing a third button, corresponding to the “colour palette” command, the user can change the colour of the brush by scrolling such colour palette with a horizontal movement of the hand. Moreover the user can change the colour shade (light/dark) by moving the hand vertically, obtaining a lighter colour with an upward movement and a darker one with a downward movement; when the button is released, the colour will be set and, therefore, by pressing the “brush” button the brush stroke imprinted on the screen has the chosen colour. Pressing the fourth button, corresponding to the “settings menu” command, the user can change the brush size by moving the hand horizontally, for example by enlarging the brush by moving the hand to the right and reducing it by moving the hand to the left; moreover, the user can change the type of brush by moving the hand vertically; releasing the button, the new brush is set.

### Example 3

A possible configuration of the main device of the present invention is explained below.

Components:

Inside the device the following components are installed/integrated:
an inertial unit with 9 degrees of freedom (accelerometer, gyroscope, magnetometer) that allows to recognize the movement and the orientation of the index finger in the space and to associate such movement to additional commands and controls;
four RGB type leds that allow to provide a visual feedback to the user;
a rechargeable battery during use;
a system for Bluetooth Low Energy and USB connection.

By means of the indications shown in FIGS. 1-10 of the patent application here presented, a skilled technician is able to construct the electronic control board card of the device in accordance with the present invention.

### Mechanical Structure:

The mechanical structure of the device includes:
the shell of the central unit that incorporates the electronic components;
a band-shaped accessory designed to be worn by the user on the back of the hand;
the universal interface between the shell of the central unit and the bend-shaped accessory, divided into two sides as previously described.

### Functionalities:

The sensors of the device can be used to acquire, on separate channels, each component of the movement detected by the accelerometer, the gyroscope and the magnetometer on the three axes X, Y and Z and to convert the data contained by these 9 signals into patterns constantly processed by the device software.

The device represents the relative orientation of the palm of the hand with respect to the user's frontal plane and by means of the six faces of a virtual cube: white if frontal, green if on the right, red if on the left, yellow if on the top, blue if below, fuchsia if behind. The RGB LEDs placed on the upper side of the central unit have the function of providing a real-time feedback to the user related to the identified direction; the feedback is represented by the corresponding colour above mentioned when the palm of the hand is aligned at least 50% to the corresponding plane.

The invention claimed is:

1. A device comprising:
at least one motion sensor;
at least one system adapted to recognize a position of the device inside a field of view of an external device worn by a user or present in a surrounding environment;
at least one electronic card adapted to communicate with the external device;
at least one device management software;
at least one universal interface consisting in two combinable parts which ensure an interlocking coupling;
at least one central unit equipped with one of two sides of the at least one universal interface and including electronic components;
at least one accessory adapted to make the device wearable;
at least one sensor configured to acquire an input from the user;
at least one visual actuator;
at least one battery;
at least one system configured to recharge the at least one battery;
at least one system configured to encode and decide information;
at least one system configured to acquire signals from different devices that are simultaneously connected;
at least one system configured to recognize a signal coming from a specific part of a human body;
at least one system configured to recognize commands associated with specific movements; and
at least one system configured to define an action corresponding to a specific movement, depending on a specific application or context.

2. The device of the claim 1,
wherein the at least one motion sensor:
is an inertial unit with nine degrees of freedom including one or more accelerometers, one or more gyroscopes, and/or one or more magnetometers;
is configured to recognize movement and orientation in space and to associate additional commands and controls to the specific movements;
is configured to recognize multiple signals, including acceleration, orientation in space and orientation with respect to the Earth's rotation axis;
wherein the system adapted to recognize the position is one or more partially or totally refracting materials or varnishes, or a color suitable to be detected by RGB or infrared sensors;
the at least one accessory is designed to fit any part of the user's body and is equipped with one side of the universal interface, so as to ensure an interlocking coupling once connected with another side of the universal interface housed on the central unit;
the sensor configured to acquire the input from the user is a pressure sensor applied on an electronic control board card and accessible through a shell of the central unit; and
the at least one visual actuator is a luminous LED luminous applied on a control board card and accessible through the shell of the central unit.

3. The device of claim 1, wherein the at least one sensor and the at least one actuator are configured to codify messages or information regarding position and movement of any part of the human body.

4. The device of claim 1, wherein the at least one accessory:
includes the at least one sensor configured to recognize the input from the user;
includes the at least one visual actuator to provide feedbacks to the user;
includes the at least one battery to provide additional power to the device;
includes at least one communication bus configured to communicate with the central unit;
is a ring- or a band-shaped tool;
has the universal interface, so as to ensure the interlocking coupling between the central unit and the at least one accessory;
is suitable to be designed in different configurations;
recognizes selected movements of the human body;
enables an interaction of the user with different external devices equipped with compatible communication systems;
is adapted to be applied for different applications, including entertainment, professional, health, music, art, or sports;
enables a simultaneous use of multiple devices, each of which is associated to a specific part of the human body;
enables a storage of data associated to the specific movements in order to analyze the data in real time or at a later time; and
enables definition and memorization of movement patterns and an association of the movement patterns with predefined commands, depending on the specific application or context of use.

5. The device of claim 1, wherein the device is adapted to be worn on any part of the human body with the at least one accessory.

6. The device of claim 5, wherein the device is adapted to be fixed on any part of the human body.

7. The device of claim 1, wherein the central unit is equipped with elements for detecting components of position and movement, elements configured to process the signal and for converting the components of position and movement into control signals, and elements configured to transmit the control signals to an external device, and wherein:
the central unit is contained in a shell equipped with one side of the at least one universal interface consisting in one or more housings;
the at least one universal interface has a shape providing an anchor coupling between the central unit and the at least one accessory; and
the at least one accessory is provided in different configurations and is adapted to be worn on any part of the human body, assuming different suitable shapes; and
is equipped with one side of the at least one universal interface.

8. The device of claim 1, wherein the device is configured to:
detect signals sent by multiple devices, identifying a source thereof;
identify an interaction context and consequently modify an output command of signal processing; and
enable the user to set up new contexts and new output of interaction with different devices.

9. The device of claim 1, wherein each of the at least one accessory is configured to include one or more of:
sensors capable of detecting user inputs,
actuators capable of providing outputs and/or feedback to the user; or
an additional battery for powering the device.

10. The device of claim 1, wherein the universal interface includes a universal communication bus which enables a data exchange between the central unit and electronic components included in the at least one accessory.
